(19) United States
(12) Patent Application Publication
(10) Pub. No.: US 2025/0373198 A1
(43) Pub. Date: Dec. 4, 2025

(54) SELF-CLEANING PHOTOVOLTAIC ROOF TILE

(71) Applicant: ML SYSTEM Spolka Akcyjna, Zaczermie (PL)

(72) Inventors: Dawid CYCON, Rzeszow (PL); Pawel KWASNICKI, Rzeszow (PL); Sylwester Korseniak, Gaj (PL); Pawel Pyrek, Tarnow (PL)

(73) Assignee: ML SYSTEM Spolka Akcyjna, Zaczermie (PL)

(21) Appl. No.: 18/876,726

(22) PCT Filed: Jun. 20, 2023
(86) PCT No.: PCT/PL2023/000031

§ 371 Date: Dec. 19, 2024

(30) Foreign Application Priority Data
Jun. 30, 2022 (PL) P.441605

(51) Int. Cl. H02S 40/10; G02B 1/14; G02B 1/18; H02S 20/25; H02S 40/20

(52) U.S. Cl. CPC H02S 40/10; G02B 1/14; G02B 1/18; H02S 20/25; H02S 40/20

(57) ABSTRACT

A self-cleaning photovoltaic roof tile including an upper transparent glass plate (4), the upper surface of which is coated with a coloured ceramic coating (5) printed thereon, with a thickness of <45 μm, which is coated with a self-cleaning hydrophobic layer (6) with a thickness of 300 nm and 800 nm, and a lower transparent glass plate (7) with an identical profile, the lower surface of which is coated with the coloured ceramic coating (8), wherein between the lower surface of the upper glass plate (4) and the upper surface of the lower glass plate (7) there is at least one monocrystalline cell (9) located above their lower sides (2), and additionally both glass plates (4, 7) together with a monocrystalline cell (9) placed between them, with electric wires (11), are laminated together by a laminating foil (10).

### CROSS REFERENCE TO RELATED APPLICATION

This application is a national stage entry of PCT/PL2023/000031 filed Jun. 20, 2023, under the International Convention and claiming priority over Poland Patent Application No. P.441605 filed Jun. 30, 2022.

### TECHNICAL FIELD

The subject of the invention is a self-cleaning photovoltaic roof tile, especially of the “plain” type and a large-format photovoltaic roof tile intended for covering the roofs of buildings, which is an alternative to traditional roofing and for converting the energy of solar radiation into electricity.

### BACKGROUND OF THE INVENTION

In recent years, research aimed at finding alternative energy sources to replace fossil fuels and crude oil deposits has focused on obtaining energy from natural sources in the environment, including solar radiation, wind and flowing water, while the sun is a very useful source of energy on many continents. Therefore, the use of photovoltaic cells on existing roofs has become a common method of generating electricity with the use of sunlight. Typically, photovoltaic panels equipped with photovoltaic cells are mounted on existing roofs, which is motivated by purely practical and functional reasons. However, these panels are very visible and spoil the aesthetics of the roof, which is noticed by both their users and bystanders, because often there is no integration between the photovoltaic panels and the rest of the roof structure.

A photovoltaic roof tile is known from the description of the Polish protective utility model No. W.124414, which is used for covering roofs and for supplying electricity, with the construction of a Rhenish type roof tile, characterized in that a longitudinal groove is made on the lower surface of the glass body of this roof tile, in which at least one photovoltaic cell is placed, and on each of the two longer walls of this groove the holes are made, in which the contact plates of photovoltaic cells are placed, wherein between this longitudinal groove and the lower front surface of this roof tile a recess is made which is intended for cooling the photovoltaic cells with air. In order for these roof tiles to generate electricity, their contact plates, at the beginning and end of the row of extreme roof tiles arranged on the roof, should be connected into an electric circuit and connected to the voltage converter. Contact plates connected by electric wires are arranged in one row of these roof tiles, creating an electric circuit connecting with the circuits of the adjacent rows of roof tiles. After placing the photovoltaic cell or cells in the groove of the body of this roof tile and connecting them by means of metal contacts, it is flooded with epoxy resin, thanks to which it is completely sealed as a whole, and the groove is supplemented to the level of the bottom surface of such a roof tile.

From the patent description of the invention in the Polish patent application P.433481, a photovoltaic roof tile is known for converting solar radiation energy into electricity, containing a counter electrode, a liquid electrolyte and a photoanode, characterized in that its photoanode is a glass plate connected with a layer of transparent conductive oxide, a nanolayer of titanium oxide deposited by the ALD method, and an “n”-type semiconductor in the form of nanocrystalline titanium oxide with adsorbed dye, to which a layer of liquid electrolyte adheres, connected to a counter electrode consisting of a layer of platinum deposited with screen printing method and a layer of transparent conductive oxide in the form of tin oxide doped with FTO fluorine or indium tin oxide (ITO) and a ceramic roof tile which is an element of the counter electrode of a pigmented photovoltaic cell.

From the patent description of the invention No. US2015/01136206A1, a roof tile is also known, which is cast from concrete in such a way that the outer surface of the wave-shaped plate is replaced with a flat surface to which the solar cell is attached, these plates being made with appropriate holes for connecting wires of solar panels. The solar panels are then electrically connected to each other on the inside surface of the roof.

The patent description of the invention No. DE10358851A1 describes a photovoltaic tile with a basic body, on the surface of which a layer of lustre is applied, which is the substrate of the photovoltaic element. It has contact elements on the base side and on the top side, which are formed from end sections of conductive paths. In the case of these photovoltaic roof tiles arranged in the roof covering, the contact element of the lower photovoltaic roof tile is adjacent on its upper side to the contact element existing on the base side of the adjacent roof tile in the upper row of roof tiles, so that the associated conductive paths are electrically connected to one another.

The patent description of the invention No. EP2443668 describes a photovoltaic roof tile for roofing having a body with a corrugated-sinusoidal profile made of a polymeric material of the type: polypropylene, polyethylene, polymethacrylate or tetrafluoroethylene having upper and lower side edges, the upper edge being shaped so as to cover the bottom edge of at least one of the adjoining roof tiles of the roofing. In addition, the body of that roof tile, on its upper surface, in addition to its two edges, has a photovoltaic layer, which is a piece of foil glued to that body with a flexible adhesive, and the upper surface of that body, in the zone covered with photovoltaic foil, has hollow cooling channels located between that body and the foil, allowing for the local flow of cooling air, wherein the photovoltaic layer is made of photovoltaic nanoparticles and electrical connectors are connected to it by means of electrical conductors so as to electrically connect the photovoltaic layers of at least two adjoining roof tiles of the roofing to each other. In turn, the upper plane of the body of this roof tile is covered with a protective mineral layer protecting against ultraviolet rays, while on the lower plane this body has a thermally insulating layer. In addition, the body of this roof tile has an electronic housing for a direct current to alternate current converter.

A photovoltaic roof tile is also known from the German patent description of the invention No. DE10358851A1, consisting of a body made of burnt clay, a layer of sodium glaze with a thickness of 100 μm to 200 μm applied to its base surface and a layer of lustre which is the base of the photovoltaic element embedded on a transparent protective layer made of glass or transparent plastic. The photovoltaic element has a layer of molybdenum applied on a layer of lustre as a substrate made of glass material with a thickness of 200 μm, divided into single back electrodes separated from each other and a layer of Cu(In,Ga)Se2 covered with a buffer layer made of CdS with a n-doped layer applied to it, divided into front electrodes separated from each other, to which the rear electrodes are assigned, whereby the molybdenum layer, the Cu(In,Ga)Se2 layer, the buffer layer and the n-doped layer form an actual photovoltaic element, and the lustre layer serves as a substrate for this photovoltaic element.

In turn, a photovoltaic roof tile is known from the patent description of the invention WO2011004092A1, composed of many roof tiles, of which at least two adjacent roof tiles overlap, at least partially, comprising a body made of a polymeric material having overlapping edges that form an upper edge and a lower edge, and a photovoltaic layer, which is a piece of foil glued to the body by means of an elastic adhesive, placed in a recess spaced from the upper surface of the body, wherein this photovoltaic layer is connected by electric wires to electric contacts, placed in recessed mounting elements, located on the overlapping two edges of the roof tile, so as to allow these overlapping edges to align when laying two adjacent roof tiles and electrical connectors.

A photovoltaic roof tile is known from the patent description of the invention WO2009006213A2, comprising: a polymer support plate to the upper surface of which the lower surface of the photovoltaic element is attached, the upper surface of this polymer support plate having a recess in which the photovoltaic element is placed, so that the upper surface of this element is flush with the upper surface of the polymer support plate, the photovoltaic element being covered with a thermoplastic polyolefin or polyacrylate, attached to the upper surface of the polymer support plate. Furthermore, the roof tile comprises an adhesive layer disposed between the lower surface of the photovoltaic element and the upper surface of the polymer support plate, which comprises a polymer-filled core material and a top layer made of the core material. In addition, the polymer support plate is made with a hole and the upper surface of the photovoltaic element has an inactive area which is attached to the lower polymer surface of this roof tile and the active area of the upper surface of the photovoltaic element is aligned with the hole of the support plate, while the overlapping part formed between the face part of the roof tile and its lower part has a hole made in it, and the photovoltaic element has an electric wire passing through this hole.

A photovoltaic roof tile is also known from the patent description of the invention WO 0030184A1, for covering roofs and providing electricity, which is a set of plates and a photovoltaic cell. The set of plates has a base part for contact with other tiles and a face part for protecting the photovoltaic cell. The compartment between the base part and the face part is filled with the photovoltaic cell and it is sealed to protect the cell from the external environment. This roof tile is configured for direct connection and overlapping with adjacent tiles, allowing water to run off them. The base part and the face part of this roof tile can be separate components that are sealed to each other, thus isolating the photovoltaic cell.

A structure of integrated photovoltaic system with glass photovoltaic tiles is also known from the patent description of the invention US2018123504 A1 disclosing a planar glass member overlaying the one or more solar cells; a substrate supporting the one or more solar cells within a cavity and affixed to the planar glass member so as to encase the one or more solar cells therebetween; and a plurality of electrical contacts electrically coupled with the one or more solar cells that are accessible from an exterior of the planar glass member and substrate affixed thereto, wherein the plurality of electrical contacts are disposed within a connector disposed along an up-roof portion of the PV roof tile that is configured to be accessible for connection with a corresponding connector from an up-roof direction when the PV roof tile is mounted on or within a roof.

The patent description of the application US2017126170 A1 describes a solar cell module comprising: a front side transparent plate; a rear face sealing plate made of glass; and a so+lar cell sealed between the front side transparent plate and the rear face sealing plate, wherein an area of the rear face sealing plate is larger than a light receiving area of the solar cell and an area of the front side transparent plate, and wherein a surplus region in which neither the solar cell nor the front side transparent plate is present on a front side of the rear face sealing plate, the solar cell module further comprising a step forming plate having a light transmissive property, the step forming plate being placed on a front side of the transparent plate in such a manner that a part of the step forming plate overlaps with a region in which the front side transparent plate is present and the remaining part of the step forming plate protrudes from the front side transparent plate.

In addition, a photovoltaic (large-format) roof tile is known from the publication on the website https://www.gramwzielone.pl/energia-sloneczna/106473/dunczycy-wprowadzaja-fotowoltaiczne-dachowki offered by the Danish company “Dansk Solenergi APS”, in various colours and waterproof, with dimensions of 1610×810×6 mm, consisting of 72 cells with dimensions of 125×125 mm, made in the well-known PERC technology, consisting in placing the insulator insert in the bottom part of the photovoltaic cell, which is responsible for limiting the passage of electrons to the back side of the module. Reflected from the insulator layer, negatively charged charges return to the conduction band and increase the total amount of electricity produced. The outer side of this tile is made of coloured glass, more resistant to mechanical damage than a ceramic roof tile.

The analysis of the above-mentioned state of the art related to the subject of the invention shows that there are known photovoltaic roof tiles differing with structures, including roof tiles of different colours, but no roof tiles have been found that have a body made of two glass plates, the upper and lower plate, the upper surface of which is covered with a colour print on a ceramic layer in a strictly defined form and which are covered with a self-cleaning layer, a deliberately selected hydrophobic layer, which meet the conditions set for the roof tile according to the invention.

### SUMMARY OF THE INVENTION

The aim of the invention is to develop a new universal construction of a photovoltaic roof tile that ensures both the generation of electricity under the influence of sunlight, self-cleaning of its outer surface and effective prevention of the growth and persistence of microorganisms, fungi and plants on its surface. A further aim of the invention is to develop such a construction of a photovoltaic roof tile that will be used in photovoltaics integrated with a given building (BIPV) and will be an alternative to conventional, traditional building materials for roofing, at the same time constituting an attractive visual complement to the roof structure.

The self-cleaning photovoltaic roof tile according to the invention is characterized in that the top surface of the transparent glass plate, is coated with a printed coloured ceramic coat, with a thickness <45 μm, which is further coated with a self-cleaning hydrophobic layer with a thickness from 300 nm to 800 nm, and the bottom surface of the lower transparent glass plate is coated with a coloured ceramic coat.

It is preferred that the coloured ceramic coating printed on the upper surface of the upper glass plate made of transparent glass with a thickness of g=3 mm to 5 mm includes a grid of dots with diameters ranging from 0.5 mm to 1.0 mm with a spacing of 0.60 mm to 0.65 mm in the “X” coordinate axis and 0.70 mm to 0.75 mm in the “Y” coordinate axis, while the ceramic coating print is made by means of the INK-JET method with a print resolution of 1440 DPI and a thickness of <45 μm, and the colour of this print is defined in the barrier space in accordance with the “CIE LAB” method, wherein the print is made on the basis of ink containing in its composition ceramic nanoparticles with layered graphics and electromagnetic wave translucency in the range of 480 nm to 980 nm and at the level of 62%. In turn, the self-cleaning hydrophobic layer covering the coloured ceramic coating contains metallic inclusions in the form of particles with a diameter of <100 nm.

It is also preferred that the upper glass plate is made of glass chemically strengthened by ion exchange method in a brine bath, and the lower glass plate is made of “float” type glass and has a thickness of g1=4-6 mm.

### BRIEF DESCRIPTION OF THE DRAWINGS

FIG. 1 shows the first variant of the self-cleaning plain-type photovoltaic roof tile in a top view,

FIG. 2 shows the same roof tile in a vertical cross section along the line A-A,

FIG. 3 shows the same roof tile shown in FIG. 2, but in the exploded state of its components,

FIG. 4 shows the same roof tile in the exploded state of its components, in a perspective view,

FIG. 5 shows two rows of the same roof tile, including three roof tiles in the first row and four the same roof tiles in the second row mounted to the lath of the roof truss in top view,

FIG. 6 shows one of the roof tiles mounted in the second upper row to the lath of the roof truss with its mounting elements in a perspective view,

FIG. 7 shows the same two rows of roof tiles shown in a vertical cross section along the line B-B in FIG. 5,

FIG. 8 shows the same two rows of roof tiles shown in a horizontal cross section along the C-C line,

FIG. 9 shows the same two rows of roof tiles mounted to the lath of the roof truss (FIG. 5) shown in the bottom view,

FIG. 10 shows the second variant of the large format self-cleaning photovoltaic roof tile in top view,

FIG. 11—the same large format roof tile in vertical cross section along the D-D line,

FIG. 12 the same large-format roof tile shown in FIG. 11—but in an unfolded state of its components,

FIG. 13—the same large-format roof tile in an exploded state of its components in a perspective view,

FIG. 14—the same large-format roof tile mounted to the lath of the roof truss in top view, and

FIG. 15—the same large-format roof tile mounted to one lath of the roof truss in the state of unfolding its components and assembly elements in a perspective view.

### DETAILED DESCRIPTION OF THE INVENTION

After installing the roof tile produced in this way, particularly the “plain” roof tile or large-format roof tile on the roof of the building, it was found that it meets the above-mentioned purpose, as it turned out that:
covering the outer upper surface of these roof tiles with a hydrophobic layer containing metallic inclusions in the form of particles with a diameter not exceeding 100 nm, ensuring the surface free energy (SFE) value below 65 mJ/m2 causes both the self-cleaning effect of this surface and the resistance to the growth and persistence of microorganisms, fungi and plants on the entire surface, while
the use of monocrystalline cells made in the BACK CONTACT architecture, connected to each other by a metallic conductive path and placing them between the upper front plate of glass laminate and the lower plate of “float” type glass, connected with each other by means of lamination foil with a monocrystalline cell placed in it, ensures proper generation of electricity under the influence of sunlight. In addition, the photovoltaic tile made in this way can be used in photovoltaic installations integrated with the building and constitutes an alternative to traditional roofing.

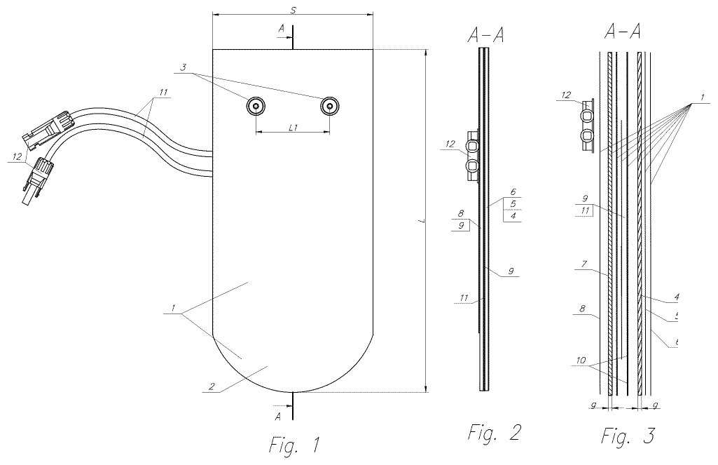

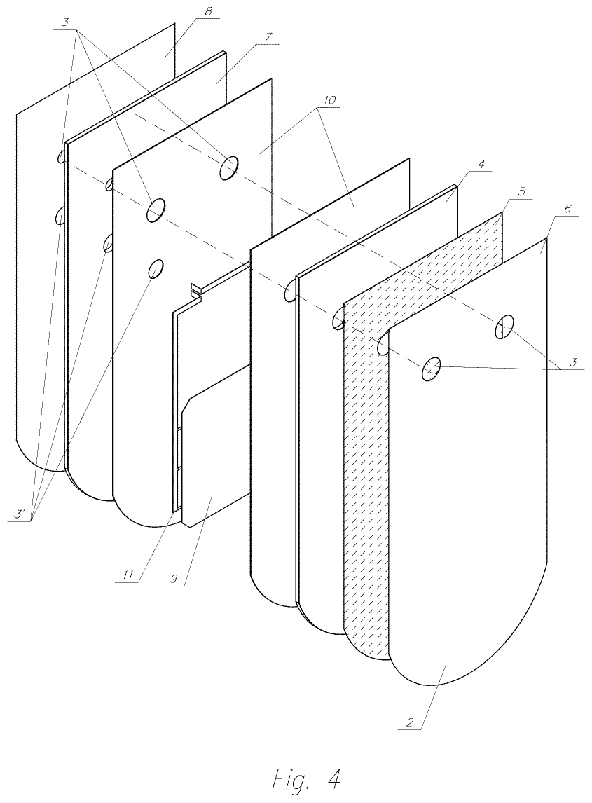

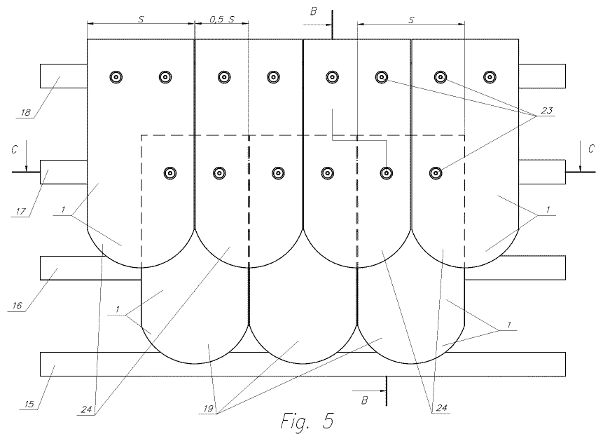

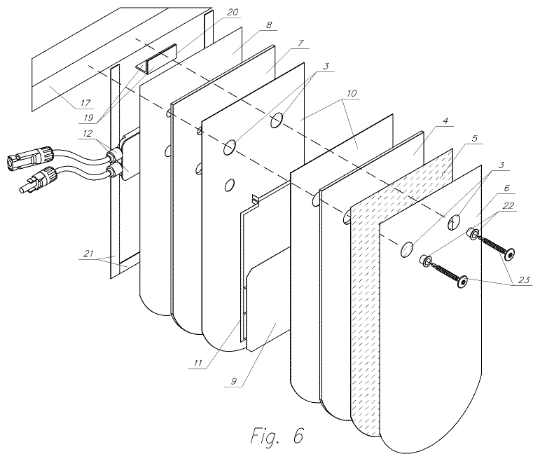

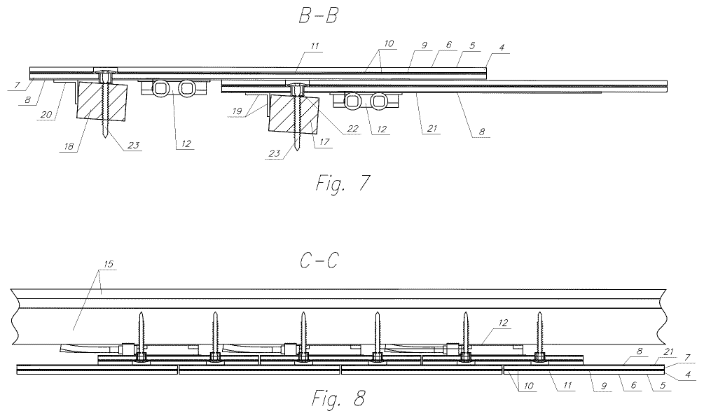

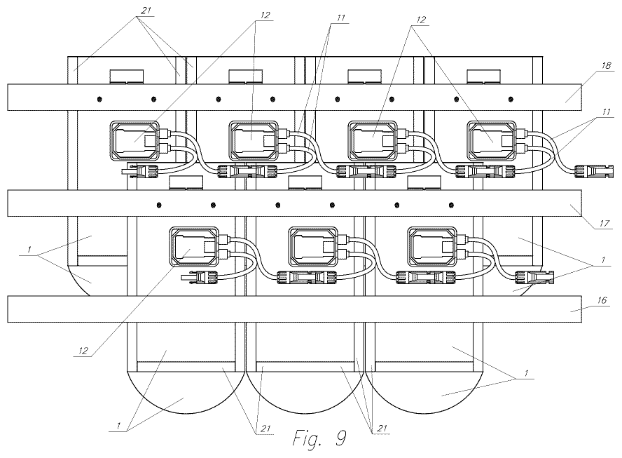

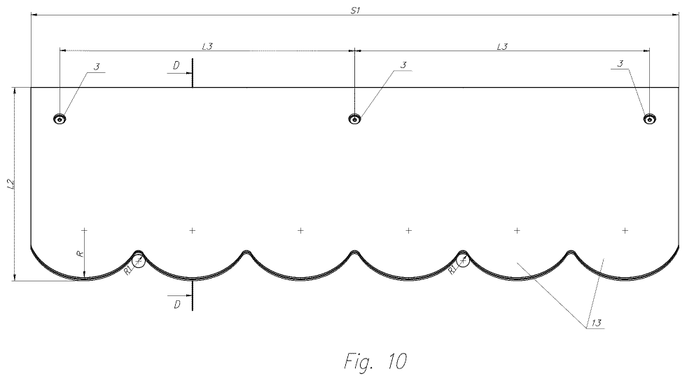

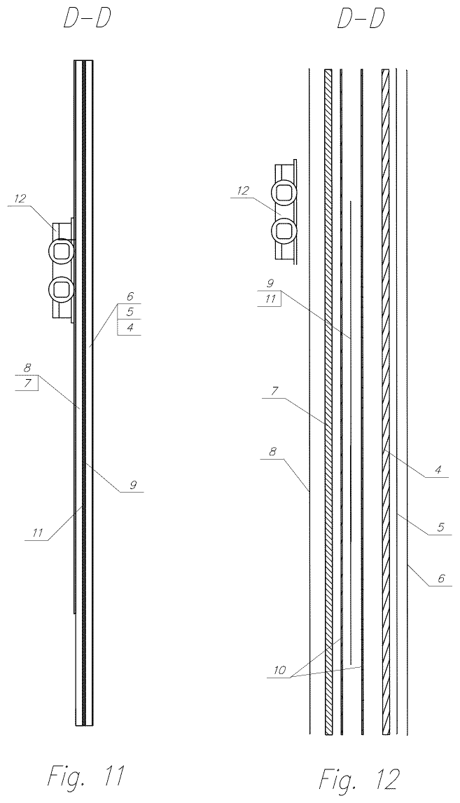

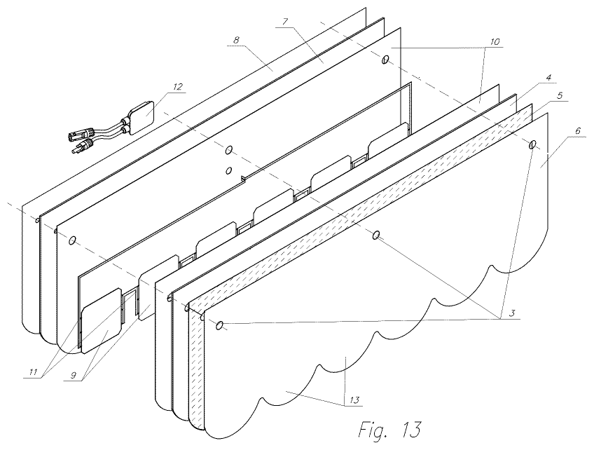

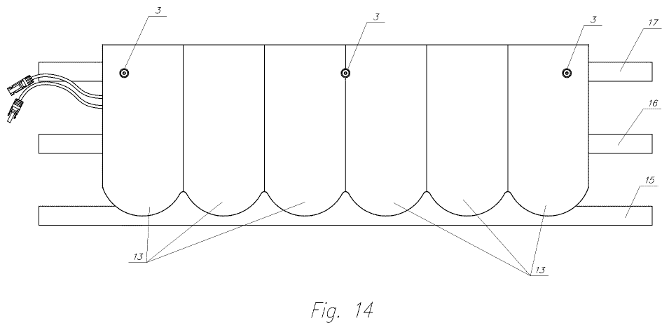

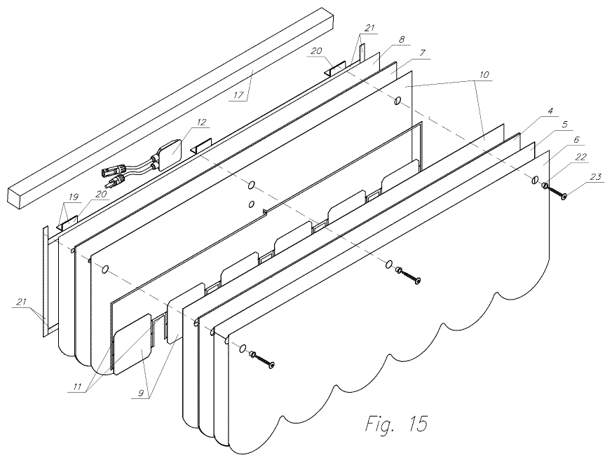

The subject of the invention in two examples of implementation and assembly to a lath of the roof truss is shown in FIG. 1-FIG. 15, in which FIG. 1 shows the first variant of the self-cleaning plain-type photovoltaic roof tile in a top view, FIG. 2—the same roof tile in a vertical cross section along the line A-A, FIG. 3—the same roof tile shown in FIG. 2, but in the exploded state of its components, FIG. 4—the same roof tile in the exploded state of its components, in a perspective view, FIG. 5—two rows of the same roof tile, including three roof tiles in the first row and four the same roof tiles in the second row mounted to the lath of the roof truss in top view, FIG. 6—one of the roof tiles mounted in the second upper row to the lath of the roof truss with its mounting elements in a perspective view, FIG. 7—the same two rows of roof tiles shown in a vertical cross section along the line B-B in FIG. 5, FIG. 8—the same two rows of roof tiles shown in a horizontal cross section along the C-C line, FIG. 9—the same two rows of roof tiles mounted to the lath of the roof truss (FIG. 5) shown in the bottom view, FIG. 10 shows the second variant of the large format self-cleaning photovoltaic roof tile in top view, FIG. 11—the same large format roof tile in vertical cross section along the D-D line, FIG. 12 the same large-format roof tile shown in FIG. 11—but in an unfolded state of its components, FIG. 13—the same large-format roof tile in an exploded state of its components in a perspective view, FIG. 14—the same large-format roof tile mounted to the lath of the roof truss in top view, and FIG. 15—the same large-format roof tile mounted to one lath of the roof truss in the state of unfolding its components and assembly elements in a perspective view.

The shape and size of the roof tiles according to the invention should not be limited to the embodiments described below and shown in FIGS. 1-15. The embodiments are presented in a way that disclosure of the invention is complete and fully conveys the scope of the invention to those skilled in the art.

To summarise, the embodiments presented below do not exhaust all possible solutions falling within the scope of the essence of the invention.

The self-cleaning photovoltaic roof tile, especially the roof tile of plain type according to the first variant of its embodiment, shown in FIG. 1-4, has the shape of a rectangular seven-layer tile 1 with a length of L=380 mm and a width of S=178 mm with its narrower lower side 2 rounded, which on its opposite upper end is made with two mounting through-holes 3 having two-stage diameters, situated coaxially to each other in the horizontal plane and at a distance of L1=82 mm, wherein it is made of the following layers:
the upper (front) transparent rectangular glass plate 4 with its narrower bottom side 2 rounded, made of transparent glass with a thickness of g=4 mm, the upper surface of which is inseparably coated with the coloured ceramic coating 5 with a thickness of 45 μm printed on it, in the form of a rectangular grid of dots (spots) with diameters of 0.5 mm with a spacing of 0.65 mm in the “X” coordinate axis and 0.75 mm in the “Y” coordinate axis, which is coated with a self-cleaning hydrophobic layer 6 with a thickness of 500 nm containing metallic inclusions in the form of particles with a diameter not exceeding 100 nm.
a lower rectangular glass plate 7 with a thickness of g1=4 mm, made of transparent of “float” type glass with a profile identical to that of the upper front rectangular glass plate 4, coated with a coloured (black) ceramic coating 8, and
a monocrystalline cell 9 placed between both of these glass plates 4 and 7, situated between their rounded lower side 2 and their upper two through-holes 3, whereby both glass plates 4 and 7 and the monocrystalline cell 9 situated between them are laminated together by means of laminating foil 10 of the EVA type, wherein the monocrystalline cell 9 is equipped with electric wires 11, which are connected with the external lead 12 of the monocrystalline cell 9 through the hole 3′ located in the upper part of the glass plate 7 under one of the mounting holes 3.

The upper (front) glass plate 4 of this roof tile is made of glass chemically strengthened by ion exchange method in a brine bath, while this roof tile was covered with a coloured print of the ceramic layer 5 made by means of the INK-JET method with a print resolution of 1440 DPI and a wet print thickness of 45 μm, and the colour of this print was determined in the colour space in accordance with “CIE Lab” and amounts to 43.78, 22.83, 20.22, while this print on the entire surface of the glass plate 4 was made on the basis of ink containing in its composition ceramic nanoparticles in layered graphics, ensuring electromagnetic wave transparency in the range of 400-980 nm at the level of 62%. In turn, the self-cleaning hydrophobic layer 6 applied to the printed layer 5 allows to obtain the surface free energy (SFE) below 65 mJ/m2, creating the effect of a self-cleaning surface. In addition, the use of the hydrophobic layer 6 applied to the upper outer surface of the glass plate 4 of this roof tile containing metallic inclusions in the form of particles with a diameter of <100 nm ensures effective prevention of the growth and retention of microorganisms, fungi and plants on the surface of the roof tile made in this way.

In turn, the self-cleaning photovoltaic roof tile according to the second variant of its embodiment, shown in FIGS. 5-13, has a seven-layer structure, similar to that of the self-cleaning photovoltaic roof tile of the “plain” type according to the first embodiment (FIGS. 1-4), and the difference between these two photovoltaic roof tiles is that the roof tile according to the second embodiment is a large-format roof tile and has a length of L2=380 mm, and a width of S1=1078 mm, and the front side on this width has six identical symmetrically arranged rounded offsets 13 with a radius of R=89 mm, connected with each other by roundings with radii of R1=1 mm, while on the opposite top end, it is made with three mounting through-holes 3 with their two-stage diameters, situated coaxially to each other in the horizontal plane at distances L3=491 mm, and in addition in this embodiment of the roof tile, over each of the offsets 13 monocrystalline cells 9 are situated, connected to each other by the electric wire 11, which connects them to the external lead 12 through the hole 3′ located under the central through-hole of the glass plate 7.

Covering the roof with these large-format tiles requires the use of fewer assembly elements and roof tiles than in the case of the first embodiment, which significantly reduces the cost of roofing and speeds up the installation of this type of roof tiles on the roof of a building.

In further embodiments, both roof tiles of the “plain” type and large format roof tiles according to the invention have:
upper—front glass plates 4 with a thickness of g=3 mm or g=5 mm
lower glass plates 7 with a thickness g1=5 mm or g1=6 mm
the dot-printed ceramic layers 5 on the upper glass plates 4 have a thickness of 20 μm or 40 μm
rectangular grids of printed dots in the ceramic layer 5 have diameters of 0.8 mm or 1.0 mm, and their spacing in the “X” coordinate axis is 0.60 mm, and in the “Y” coordinate axis is 0.70 mm
the metallic inclusions of the hydrophobic layer 6 applied to the upper outer surface of the front glass plate 4 have diameters of 50 nm or 90 nm
the self-cleaning hydrophobic layer 6 with a thickness of 300 nm or 800 nm
the lower, wider sides of the large-format roof tiles have two or four or six rounded offsets 13 with radii R=90 mm or R=98 mm, connected to each other with radii R1=6 mm or R1=10 mm

Installation of both types of these roof tiles, as shown in FIGS. 5-9 and FIGS. 14 and 15, is implemented in a similar way and consists in starting from the lower end of the roof truss equipped with lathes located horizontally and parallel to each other, for example 15, 16, 17, 18 and further lathes located above them (not shown on in the drawing) in the amount depending on the height of the roof and in the distance from each other depending on the length “L” or “L2” of these roof tiles.

In the case of roof tiles 1 of the “plain” type, their installation, as shown in FIG. 5-9, consists in the fact that on a third lath 17, when counting from the lower end of the roof truss, which is equipped with support angles 19, rubber seals 21 with a U-profile are placed on one of their arms 20, and then the roof tiles are laid on them so that their longer sides adhere to each other, and in their two-stage holes 3, including the holes of a larger diameter made in the lower glass plate 7 of this roof tile, distance sleeves 22 are embedded so that they adhere with their lower ends to the lath 17, and then in the holes 3 and in the sleeves 22 screws 23 are inserted and screwed into these lathes 17, with screw heads pressed to the upper surfaces of the glass plates 7 of the roof tiles 1, with the lower surfaces of the distance sleeves 22 simultaneously pressed to the upper surfaces of the lathes 17. After installing the first row of roof tiles 1 to the lath 17, another row 24 of these roof tiles 1 is placed on the next lath 18 located higher and parallel to the lath 17, with the first and further roof tiles of this row 24 shifted by half their width, and then the tiles are mounted on a lath 18 in the same way as they were installed in the first row 17 with the use of support angles 19, rubber seals 21 and distance sleeves 22, so that the upper row of these roof tiles 1 partially covers the lower row, obtaining the effect of so called “fish scale”, and then the process of installing the roof tiles 1 is repeated on the successive higher laths of the roof truss.

As a result of arranging the roof tiles 1 with their upper row 24 shifted by half of their width “S” in relation to the lower row 19, their upper row always has a line of contact shifted in half the width S (0.5S) of the lower row 19, so that the subsequent rows of roof tiles 1 cover the contact points of the lower rows, thus ensuring tightness of the entire roofing system with these roof tiles.

1. A self-cleaning photovoltaic roof tile comprising:
a comprising an upper plate-shaped hardened glass element,
a lower plate-shaped hardened glass element laminated to each other be a laminating foil, both elements having identical rectangular shape with lower sides rounded and both provided with mounting holes situated coaxially with respect to each other, and
at least on photovoltaic cell disposed between the glass elements over their lower sides and equipped with electric wires connected to an external terminal wherein a top surface of the transparent glass plate (4) is coated with a printed coloured ceramic coat (5) with a thickness <45 μm, which is further coated with a self-cleaning hydrophobic layer (6) with a thickness from of 300 nm to 800 nm, and a bottom surface of a lower transparent glass plate (7) is coated with a coloured ceramic coat.

2. The self-cleaning photovoltaic roof tile according to claim 1, wherein the coloured ceramic coating (5) printed on the upper surface of the upper glass plate (4) made of transparent glass with a thickness of g=3 mm to 5 mm includes including a grid of dots with diameters ranging from 0.5 mm to 1.0 mm with a spacing of 0.60 mm to 0.65 mm in the “X” coordinate axis and 0.70 mm to 0.75 mm in the “Y” coordinate axis.

3. The self-cleaning photovoltaic roof tile according to claim 1, wherein the colour print of the ceramic coating (5) is made by means of the INK-JET method with a print resolution of 1440 DPI and a wet print thickness <45 μm, and the colour of this print is determined in the colour space in accordance with the “CIE LAB” method, wherein the print is made based on ink containing in its composition ceramic nanoparticles with layered graphics and electromagnetic wave translucency in the range from 480 nm to 980 nm and at the level of 62%.

4. The self-cleaning photovoltaic roof tile according to claim 1, wherein the self-cleaning hydrophobic layer (6) covering the coloured ceramic coating (5) contains metallic inclusions in the form of particles with a diameter of <100 nm.

5. The self-cleaning photovoltaic roof tile according to claim 1, wherein the upper glass plate (4) is made of glass chemically strengthened by ion exchange method in a brine bath.

6. The self-cleaning photovoltaic roof tile according to claim 1, wherein the lower glass plate (7) is made of “float” type glass and has a thickness of g1=4 mm-6 mm.

7-10. (canceled)
